(19) United States
(12) Patent Application Publication
(10) Pub. No.: US 2026/0108862 A1
(43) Pub. Date: Apr. 23, 2026

(54) GAS-LIQUID CONTACT PACKING

(71) Applicant: TO-TOKU Engineering Co.,Ltd, Misato-city (JP)

(72) Inventor: Jiro OTA, Misato-city (JP)

(21) Appl. No.: 19/360,983

(22) Filed: Oct. 17, 2025

Related U.S. Application Data
(63) Continuation of application No. PCT/JP2025/018770, filed on May 23, 2025.

(30) Foreign Application Priority Data
Oct. 21, 2024 (JP) 2024-185629

(51) Int. Cl. B01J 19/32

(52) U.S. Cl. CPC B01J 19/32; B01J 2219/3222; B01J 2219/32491

(57) ABSTRACT

A gas-liquid contact packing that has high gas-liquid contact efficiency and can be formed from lightweight and inexpensive materials is obtained. Each of the belt materials 41 having gaps between yarns 46 is made of a woven or knit fabric, the woven or knit fabric is formed from composite yarns 44 including a monofilament and a wire, a combination of monofilament yarns 42 composed of one or more monofilaments and wire yarns 43 composed of one or more wires, or a combination of all or two kinds among the monofilament yarns 42, the wire yarns 43, and the composite yarns 44, each of the belt materials is formed in an accordion shape by alternately repeating mountain folds and valley folds in a direction crossing a longitudinal direction of the belt material 41, and the belt materials 41 with the accordion shape are layered.

### CROSS-REFERENCE TO RELATED APPLICATIONS

This Application claims the benefit of priority and is a Continuation application of the prior International Patent Application No. PCT/JP2025/018770, with an international filing date of May 23, 2025, which designated the United States, and is related to the Japanese Patent Application No. 2024-185629, filed Oct. 21, 2024, the entire disclosures of all applications are expressly incorporated by reference in their entirety herein.

### TECHNICAL FIELD

The present invention relates to a gas-liquid contact packing that maintains low pressure loss inside apparatus such as distillation towers, absorption towers, cooling water towers, and water treatment facilities involving air oxidation, and causes gas and liquid to contact in counterflow, parallel flow, or crossflow to effectively perform mass transfer, heat transfer, chemical transfer, or any combination thereof between gas and liquid phases.

### BACKGROUND ART

Gas-liquid contact packings include irregular packings that are randomly filled without consideration of individual positions or orientations within the apparatus space as shown in Patent Document 1, and structured packings that are pre-dimensioned and manufactured to be regularly arranged inside the apparatus. Structured packings used generally are formed by corrugating thin plates or mesh plates made of metal, plastic, or the like and laminating the corrugated plates, or by weaving multiple fine wires.

Since these conventional structured packings have functions that the materials themselves can maintain three-dimensional shapes, when housed in the apparatus, there is little risk that the shapes or positions of the packings will change due to fluid influence, which makes it possible to maintain the initial filling state until the end. Unfortunately, such conventional packings are limited to materials capable of maintaining three-dimensional shapes within the apparatus, thereby it is difficult to achieve ideal gas-liquid contact conditions, and problems arise such as high cost, heavy weight, and the like.

To solve such problems, it would be ideal to form woven or knit fabrics using fiber materials such as natural fibers, chemical fibers, glass fibers, carbon fibers, etc., that can be easily mass-produced industrially, and use them as gas-liquid contact packings. This is because using such materials would make it possible to make the overall apparatus weight lighter, and through obtaining high liquid retention capability (water retention) due to wide surface area and capillary action, improvement in gas-liquid contact efficiency could be expected.

### PRIOR ART DOCUMENT

### Patent Document

Patent Document 1: Japanese Unexamined Patent Application Publication No. H11-090218

### SUMMARY OF INVENTION

### Problem to be Solved by the Invention

Unfortunately, when the woven or knit fabrics formed only of fibers as described above are used for gas-liquid contact packings, a problem arises that it becomes difficult to maintain three-dimensional shapes due to their softness when the woven or knit fabrics are packed as packings inside the apparatus. Furthermore, sufficient discussion has not been conducted regarding the usefulness of using the woven or knit fabrics formed from such fibers as packing materials, and conventionally, gas-liquid contact packings using the woven or knit fabrics formed from such fibers as main materials have not been put to practical use.

The present invention seeks to solve the above-mentioned problems, and discloses a gas-liquid contact packing that has high gas-liquid contact efficiency and can be formed from lightweight and inexpensive materials.

### Means for Solving the Problem

To solve the above-mentioned problems, one aspect of the present invention provides a gas-liquid contact packing comprising belt materials having gaps between yarns, wherein each of the belt materials is made of a woven or knit fabric, the woven or knit fabric is formed from composite yarns including a monofilament and a wire, a combination of monofilament yarns composed of one or more monofilaments and wire yarns composed of one or more wires, or a combination of all or two kinds among the monofilament yarns, the wire yarns, and the composite yarns, and the belt materials having the gaps are layered. In the present application, the simply expressed term “yarn” is used as a generic term referring to the composite yarn, the wire yarn and the monofilament yarn as an upper level concept.

Herein, one preferable condition for the gas-liquid contact packing is to make the surface area of the gas-liquid contact packing per unit volume of the apparatus as wide as possible, and widening the surface area causes the amount of gas-liquid contact to increase. On the other hand, widening the surface area increases the packing density, and thereby, conventional packings caused a risk that gas fluid resistance would increase and gas processing capacity would decrease. Thus, to obtain higher performance gas-liquid contact packings, it is necessary to increase the surface area while simultaneously maintaining gas fluid resistance as low as possible.

Furthermore, by forming the gas-liquid contact packing of the woven or knit fabrics made of monofilaments having wide surface area and high liquid retention capability (water retention), gas-liquid contact is performed uniformly when the entire surface of the gas-liquid contact packing is wetted, and it is considered that this can further improve the gas-liquid contact effect. Having both gas and liquid spread uniformly throughout the entire apparatus while simultaneously moving at uniform velocity and performing the gas-liquid contact is also important for improving gas-liquid contact effects.

As described above in the present invention, the woven or knit fabrics are formed from yarns made by combining one or multiple monofilaments and one or multiple wires, which can cause the overall surface area to be wide. By forming such woven or knit fabrics, it is possible to obtain the belt materials having gaps between the yarns. The presence of the aforementioned gaps can reduce gas fluid resistance, gas and liquid pass through the gaps, thereby both gas and liquid spread uniformly throughout the entire apparatus, and gas-liquid contact is easily performed at uniform velocity.

As described above in the present invention, since the yarns composed of combination of one or more monofilaments and one or more wires are used, the presence of the wires makes it possible to maintain three-dimensional shapes favorably without causing shape collapse even when the woven or knit fabrics are formed from the yarns. As materials for the monofilaments in the present invention, for example, fiber materials that can be easily mass-produced industrially such as natural fibers, chemical fibers, glass fibers, carbon fibers, etc. can be used. As materials for the wires, for example, materials such as stainless steel, copper, nickel, titanium, etc. can be used.

Each of the belt material may be formed in an accordion shape by alternately repeating mountain folds and valley folds in a direction crossing a longitudinal direction of the belt material, and the belt materials with the accordion shape may be layered.

The aforementioned belt material may be made of yarns composed of one or multiple monofilaments and one or multiple wires. The belt material may be made of the monofilament yarns composed of one or multiple monofilaments, the wire yarns composed of one or multiple wires, and the composite yarns composed of one or multiple monofilaments and one or multiple wires. The monofilaments according to the present invention refer to short fibers and/or long fibers. Twisted short fibers, converged long fibers, combinations of short and long fibers, etc. can be used for the yarns including the monofilaments, and can be appropriately selected depending on the application.

The aforementioned belt materials are made of the woven or knit fabrics, and thereby, fluid can pass through the gaps between the yarns. Thus, gas not only flows along liquid film surfaces formed by diffusion on the belt material surfaces, but also passes through the gaps between the yarns that liquid adheres to and countless minute gas-liquid contacts occur simultaneously, thereby the contact interface between both fluids (gas and liquid) is constantly renewed, which enables efficient gas-liquid contact.

Each of the aforementioned belt material may be formed in the accordion shape by alternately repeating the mountain folds and the valley folds in the direction crossing the longitudinal direction of the belt material, and the belt materials may be layered alternately front and back. Layering the belt materials in this way enables the mountain fold side of one belt material to face and bring into contact with the mountain fold side of another belt material, and gas and liquid that move vertically or horizontally along the belt materials from the contact portions tend to repeatedly combine and disperse.

As described above in the present invention, since the belt materials can be formed by appropriately selecting the monofilament yarns, the wire yarns, and the composite yarns, for example, increasing the proportion of the wires in the belt materials enhances the rigidity of the belt materials as shown in FIG. 8A, and widening the interval between the mountain folds and the valley folds of the accordion shapes can increase the processing capacity of the fluids as shown in FIG. 9A. In contrast, by decreasing the proportion of the wires in the belt material as shown in FIG. 8B, it is possible to narrow the interval between the mountain folds and the valley folds of the accordion shapes as shown in FIG. 9B, and to widen the surface area of the gas-liquid contact packing.

The aforementioned belt materials may be wound from one end to the other end in a longitudinal direction of the belt materials. By winding the belt materials to form the packing in this way, the production is easy and no other special parts are required. This can keep the manufacturing costs low.

### Effect of the Invention

As described above, since the present invention provides the packing made of the woven or knit fabrics formed from the composite yarns including a monofilament and a wire, a combination of the monofilament yarns composed of one or more monofilaments and the wire yarns composed of one or more wires, or a combination of all or two kinds among the monofilament yarns, the wire yarns, and the composite yarns, it is possible to inexpensively and easily obtain the products with wide overall surface area and light weight. Furthermore, at the crossing positions of warp and weft yarns in the woven fabrics, or yarn crossing positions in the knit fabrics, gas flowing upward or moving horizontally along the yarns and descending liquid repeatedly converge and disperse, which makes it possible to obtain effective flow characteristics where the contact interface between both fluids (gas and liquid) is constantly renewed.

In addition, since the packing is formed of the belt materials having the gaps between the yarns, the presence of the gaps can reduce gas fluid resistance. The aforementioned yarns according to the present invention are composed of one or multiple wires and monofilaments, and thereby, liquid diffuses overall on the monofilament surfaces by capillary action of the yarns to form uniform flow. This causes liquid effective velocity to become uniform throughout the entire apparatus, and effective gas-liquid contact is performed. By liquid diffusing uniformly throughout the entire apparatus in this way, sufficient gas-liquid contact effects can be achieved through good wetting characteristics.

Furthermore, since the packing according to the present invention is made by combining the monofilaments and the wires, even when the woven or knit fabrics are formed using these, it becomes possible to maintain the three-dimensional shape favorably due to the presence of the wires. Regarding liquid that has moved from the monofilaments to the wires, capillary action becomes less likely to occur, and thereby, the liquid tends to form droplets on the wire surfaces. These droplets subsequently move again to the monofilaments and diffuse in the monofilaments to form thin liquid films.

In this way, by combining different materials of the monofilaments and the wires, overall, droplet appearance and dispersion, and their recombination and separation occur successively. It is generally known that flow of the contact gas-liquid interface and the frequent interface changes play important roles for effective mass transfer, heat transfer, or chemical reactions between gas and liquid, and the gas-liquid contact action by combining different materials of the monofilaments and the wires fulfills this role.

### BRIEF DESCRIPTION OF DRAWINGS

FIG. 1 is a plan view showing a belt material according to Example 1 of the present invention.

FIG. 2 is a partly enlarged perspective view showing the belt material according to Example 1.

FIG. 3 is a cross-sectional view along line A-A in FIG. 1.

FIG. 4 is a perspective view showing a state where multiple belt materials are layered in Example 1.

FIG. 5 is a partly enlarged end view of FIG. 4.

FIG. 6 is a partly enlarged perspective view showing a state where a packing according to Example 1 is packed in a packed tower.

FIG. 7 is a perspective view showing Example 2 according to the present invention.

FIGS. 8A and 8B are partly enlarged plan views showing belt materials according to Examples 3 and 4.

FIGS. 9A and 9B are end views showing belt materials formed in accordion shapes according to Examples 3 and 4.

### EXAMPLE 1

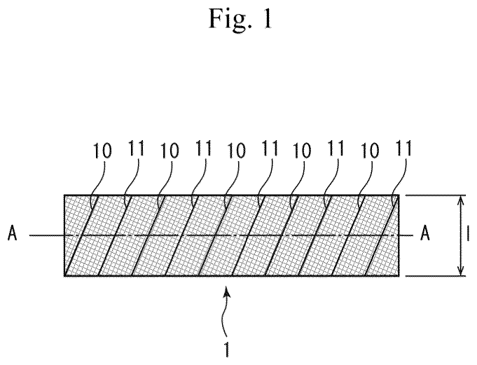

With reference to figures to explain Example 1 according to the present invention, (1) is a belt material, this belt material (1) is formed in a belt shape of constant width by knitting yarns (2), and the width l of the belt material (1) is 100 mm as shown in FIG. 1. Each of the yarns (2) is made by combining nine monofilaments (not shown) and one wire (not shown). Each of the monofilaments is a polyester fiber with a diameter of 0.23 mm, and the wire is made of stainless steel with a diameter of 0.25 mm.

By using the yarns (2) including the wire as described above, even when the belt material (1) is formed with the yarns (2) and bent into a three-dimensional shape, the presence of the wire allows the shape to be maintained favorably even during use. The wire with a diameter of 0.25 mm is used as described above in the present example, but from the viewpoint of shape retention, it is preferable to use the wire with a diameter of 0.2 mm to 0.4 mm. When knit fabrics are formed using the yarns (2) including the wire, the wires bend alternately up and down and firmly intertwine, and thereby, it is possible to obtain a packing (13) with a robust structure when the belt materials (1) are processed into accordion shapes.

Each of the yarns (2) according to the present example are formed of nine monofilaments and one wire as described above, which is not limited in other different examples. It is possible to change the number of monofilaments and the number of wires according to appropriate applications and use the yarns (2) with various combinations. The belt materials (1) are formed by knitting the yarns (2) in the present example and the following Example 2, which is not limited in other different examples. As shown in Examples 3 and 4 described below, the belt materials (1) may be formed by weaving the yarns (2).

Furthermore, since the yarns (2) according to the present invention are composed of multiple monofilaments in addition to the wire, capillary action of the monofilaments causes liquid to diffuse over the entire surfaces of the monofilaments to form uniform flow. This causes liquid descent velocity to become uniform throughout the entire packed tower (12), and effective gas-liquid contact is performed. Since liquid diffuses uniformly throughout the entire packed tower (12) in this way, sufficient gas-liquid contact effects can be achieved through good wetting characteristics. The belt materials (1) according to the present example are formed by knitting the yarns (2) composed of multiple monofilaments and the wire, which makes it possible to obtain products that are easy to manufacture, are inexpensive, have wide overall surface area, and are lightweight.

Gas flowing upward or moving horizontally along the yarns (2) and descending liquid repeatedly converge and disperse at the crossing positions of the yarns (2) in the knit fabrics, thereby the contact interface between both fluids (gas and liquid) is constantly renewed, and this makes it possible to obtain effective flow characteristics. Forming the belt materials (1) of the knit fabrics with the above configuration causes gaps to be formed between one yarn (2) and another yarn (2), and the presence of the gaps can reduce gas fluid resistance. This can increase fluid processing speed and improve efficiency.

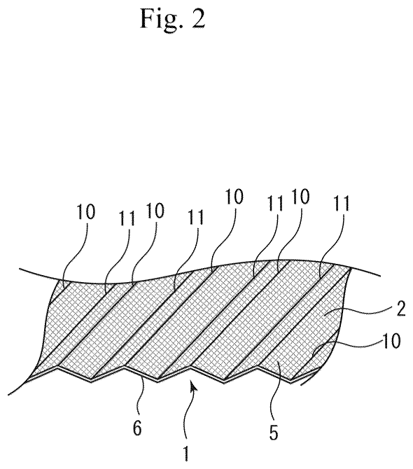

As shown in FIGS. 1 and 2, each of the belt materials (1) is processed and formed in the accordion shape by alternately repeating mountain folds and valley folds in an inclined direction that is non-perpendicular to the longitudinal direction, which is the same direction as line A-A in FIG. 1. It should be noted that each of the accordion-shaped belt material (1) may be formed of one fabric, or the accordion-shaped belt materials (1) may be formed of layered multiple fabrics.

The packing (13) is formed by processing the belt materials (1) into the accordion shape as described above in the present example and the following Example 2, which is not limited in other different examples. It is also possible to use the layered multiple belt materials (1) as the packing without processing them into the accordion shape.

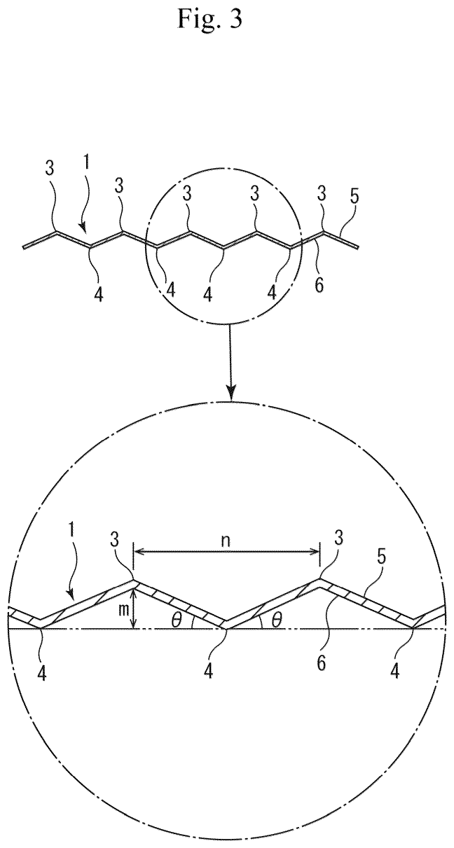

As shown in FIG. 3, in the cross-sectional shape of the belt material (1), assuming that the front or back surface of the belt material (1) is placed on a horizontal plane, the inclination angle θ of the mountain folds and the valley folds relative to the horizontal line shown by the two-dot chain line is 30°. Furthermore, as shown in FIG. 3, the vertical distance m between the peaks (3) of the mountain folds and the peaks (4) of the valley folds is 10 mm, and the horizontal distance n between the adjacent mountain peaks (3) is 20 mm.

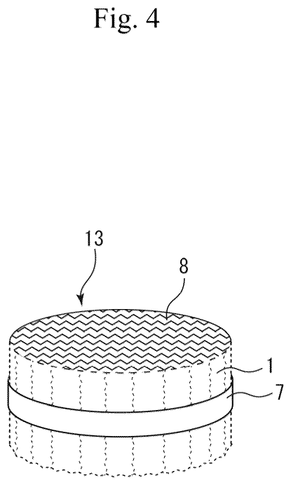

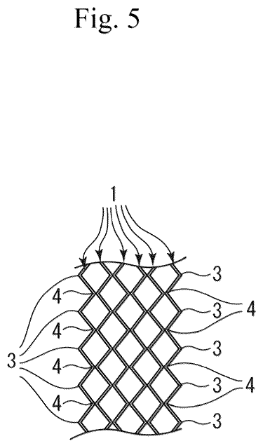

Next, the aforementioned accordion-shaped belt material (1) is cut to a predetermined length to form multiple belt materials (1). Then, as shown in FIGS. 4 and 5, these multiple belt materials (1) are layered alternately front and back so that the accordion directions of each adjacent belt material (1) are in opposite directions, that is, so that the front surfaces (5) and the back surfaces (6) of the adjacent belt materials (1) are respectively adjacent to each other. Then, as shown in FIG. 4, the layered belt materials are bundled so that the adjacent belt materials (1) are in close contact and the whole becomes cylindrical, and a thin belt-shaped metal (7) is wound around the outer periphery for fixation to make one unit (8).

Layering and bundling the belt materials (1) as described above cause the mountain folds of one belt material (1) to closely contact the mountain folds of another belt material (1) as shown in FIG. 5, and thereby, gas and liquid easily repeatedly combine and disperse through both the belt materials (1) from the contact portions. Since the aforementioned belt materials (1) are composed of the knit fabrics, it is also possible for fluid to pass through between one yarn (2) and another yarn (2). That is to say, gas not only flows and contacts along liquid film surfaces formed by diffusion on the surfaces of the belt materials (1), but also passes through the gaps between the yarns (2) that liquid adheres to, and thereby, countless minute gas-liquid contacts also occur simultaneously. This causes the contact interface between both fluids (gas and liquid) to be constantly renewed and enables efficient gas-liquid contact.

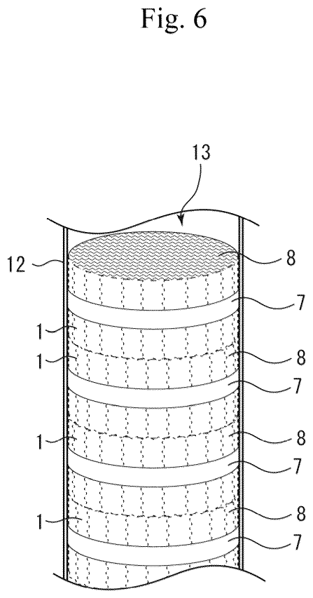

As shown in FIG. 6, the diameter of this unit (8) is made approximately the same as the inner diameter of the packed tower (12) in which the unit (8) is filled, and it is adjusted in advance so that the belt materials (1) are laid out without gaps in the cross-sectional direction of the packed tower (12). In other different examples where the cross-sectional area of the packed tower (12) is even wider than that in the present example, and one unit cannot fill the cross-section of the packed tower, it becomes possible to lay out the belt materials (1) without gaps in the packed tower by arranging and laying a plurality of the units in the cross-sectional direction of the packed tower.

Furthermore, in the present example, the unit (8) composed of the belt materials (1) is packed in the packed tower (12) so that the width direction of the belt materials (1) is arranged in the vertical direction of FIG. 6, the unit being used for gas-liquid counterflow contact apparatus. This makes it possible to smoothly raise gas along the ridge lines (10) and (11) of mountains and valleys of the belt materials (1) included in the packing shown in FIG. 2.

### EXAMPLE 2

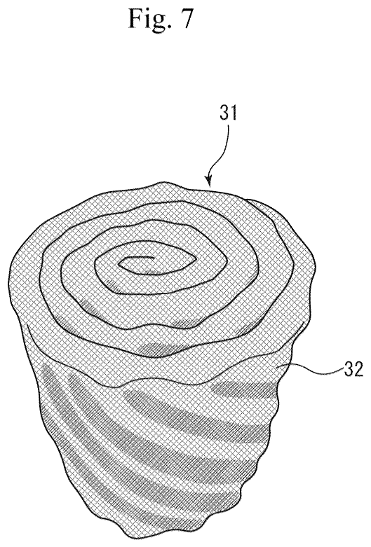

In Example 1, the multiple belt materials (1) are bundled to form the unit (8) and then the unit (8) is packed in the packed tower (12) as described above. In the present Example 2, a packing (31) is used when it is filled in a packed tower with a diameter of, for example, 0.3 m or less, as shown in FIG. 7, the packing (31) is formed by layering a pair of belt materials (32) with front surfaces (5) or back surfaces (6) facing each other, and winding the belt materials in this state multiple times in the same direction from one end to the other end in the longitudinal direction of the belt materials (32). This makes the production easy and requires no other special parts, which can keep costs low. The belt materials (32) used for the present example are bent and formed in the accordion shape similar to Example 1.

### EXAMPLE 3

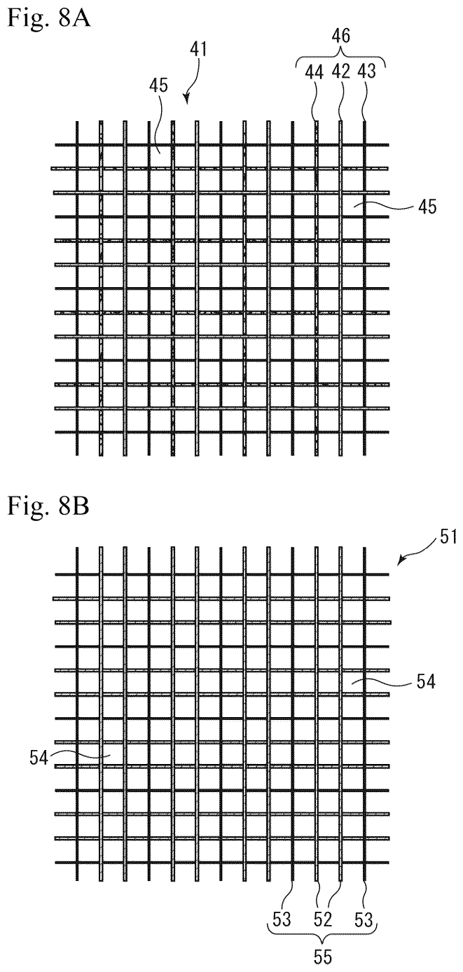

In Examples 1 and 2, the belt materials (1) and (32) are formed by knitting the yarns (2). In the present Example 3 and the following Example 4, belt materials (41) and (51) are formed by weaving yarns (46) and (55). For the yarns (2) according to Examples 1 and 2, only one kind of the composite yarns made by combining nine monofilaments (not shown) and one wire (not shown) is used. For the yarns (46) according to the present Example 3, as shown in FIG. 8A, three kinds of yarns including monofilament yarns (42) composed of multiple monofilaments, wire yarns (43) composed of multiple wires, and composite yarns (44) composed of multiple monofilaments and multiple wires are used, and the belt materials (41) are formed by alternately arranging three kinds of the yarns through gaps (45). The other configurations of the packing according to the present example are the same as those in Example 1.

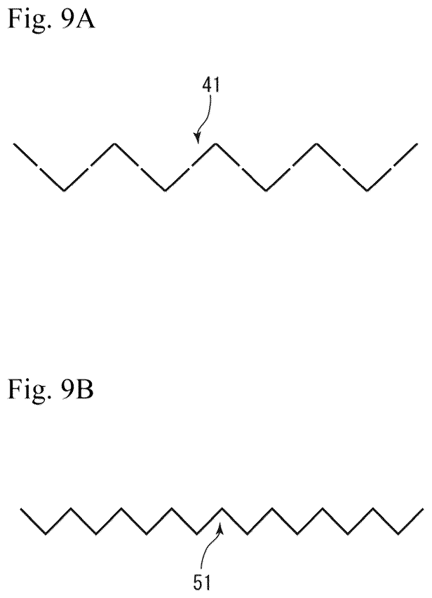

By selecting the monofilament yarns (42), the wire yarns (43), and the composite yarns (44) to make the belt materials (41) in this way, the proportion of the wires in the belt materials (41) becomes relatively high. This makes it possible to increase the rigidity of the belt materials (41) as a whole, widen the interval between the mountain folds and the valley folds of the accordion-shaped belt materials (41) as shown in FIG. 9A, and increase the fluid processing capacity of the packing as a whole.

### EXAMPLE 4

For the belt materials according to the present Example 4, as shown in FIG. 8B, belt materials (51) are formed by using monofilament yarns (52) composed of multiple monofilaments and wire yarns (53) composed of multiple wires, and repeating a configuration where two monofilament yarns (52) are arranged between two wire yarns (53) through gaps (54). The other configurations of the packing according to the present example are the same as those in Example 1.

By forming the belt materials (51) with a higher proportion of the monofilament yarns (52) than that pf the wire yarns (53) in this way, the proportion of the wires in the belt materials (51) is made less than that in Example 3. Since the belt materials (51) according to the present example have lower rigidity than the belt materials (41) according to Example 3, the interval between the mountain folds and the valley folds of the accordion-shaped belt materials (51) is formed narrower as shown in FIG. 9B. This makes it possible to widen the surface area of the packing, and increasing the proportion of the monofilaments can make the weight of the entire apparatus relatively light.

### DESCRIPTION OF REFERENCE NUMERALS

1, 32, 41, 51 belt material
2, 46, 55 yarn
42, 52 monofilament yarn
43, 53 wire yarn
45, 54 gap
46, 55 yarn

What is claimed is:

1. A gas-liquid contact packing comprising belt materials having gaps between yarns, wherein
each of the belt materials is made of a woven or knit fabric,
the woven or knit fabric is formed from composite yarns including a monofilament and a wire, a combination of monofilament yarns composed of one or more monofilaments and wire yarns composed of one or more wires, or a combination of all or two kinds among the monofilament yarns, the wire yarns, and the composite yarns, and
the belt materials having the gaps are layered.

2. The gas-liquid contact packing according to claim 1, wherein
each of the belt materials is formed in an accordion shape by alternately repeating mountain folds and valley folds in a direction crossing a longitudinal direction of the belt material, and
the belt materials with the accordion shape are layered.

3. The gas-liquid contact packing according to claim 1, wherein
the belt materials are made of yarns composed of one or multiple monofilaments and one or multiple wires.

4. The gas-liquid contact packing according to claim 1, wherein
the belt materials are made of the monofilament yarns composed of one or multiple monofilaments, the wire yarns composed of one or multiple wires, and the composite yarns composed of one or multiple monofilaments and one or multiple wires.

5. The gas-liquid contact packing according to claim 1, wherein
each of the belt materials is formed in an accordion shape by alternately repeating mountain folds and valley folds in a direction crossing a longitudinal direction of the belt material, and
the belt materials are layered alternately front and back.

6. The gas-liquid contact packing according to claim 1, wherein
the belt materials are wound from one end to the other end in a longitudinal direction of the belt materials.
